(19) United States
(12) Patent Application Publication
(10) Pub. No.: US 2024/0377370 A1
(43) Pub. Date: Nov. 14, 2024

(54) METHODS FOR MONITORING CHROMATOGRAPHY RESINS DURING CONTINUOUS CHROMATOGRAPHY OPERATION

(71) Applicant: MERCK PATENT GMBH, Darmstadt (DE)

(72) Inventors: Damien Kervennic, Strasbourg (FR); Philippe Moissonnier, Ville (FR)

(21) Appl. No.: 18/687,181

(22) PCT Filed: Sep. 27, 2022
(86) PCT No.: PCT/EP2022/076839

§ 371 Date: Feb. 27, 2024

(30) Foreign Application Priority Data
Sep. 28, 2021 (EP) 21306337.3

(51) Int. Cl. G01N 30/86; G01N 30/88

(52) U.S. Cl. CPC G01N 30/8617; G01N 30/88; G01N 2030/8804; G01N 2030/889

(57) ABSTRACT

Methods for the monitoring of quality and efficiency of chromatography columns operated in continuous mode without disruption of column operation by monitoring buffer change followed by smoothing and derivation of the recorded values.

### BACKGROUND

Column chromatography is used extensively in biotech industry to purify product. Typically, target therapeutic proteins such as insulin or monoclonal antibodies are produced in prokaryotic or eukaryotic cells. The target proteins then need to be purified from the culture media, cells, cell debris and any other impurity resulting for the culturing process. Column chromatography is used to separate the target protein by, for example, charge differences between the target protein and impurities, affinity of the target protein or impurities to a ligand and size exclusion. Most purification protocols require several different chromatography steps in sequence to purify the target protein.

Chromatography operation requires regular checks of column efficiency by testing the quality of the packed bed through the HETP (Height of Equivalent Theoretical Plate) test. This test is generally done by taking the column out of production and using pulse analysis.

Traditionally, biomanufacturing has been performed in batch mode, with each stage requiring a holding tank or equivalent to hold product in between sequential steps. This requires stopping and starting the process, costing time, and the use of storage vessels, costing valuable space. Continuous processing is the concept of having the raw material (i.e., the cultured engineered cells and media) enter one end of a manufacturing process and have product come out the other end without the need of holding tanks or stopping and starting of the process. However, continuous process makes it nearly impossible to effectively and consistently monitor the quality and efficiency of chromatography columns. What is needed in the art are methods for monitoring chromatography quality without having to stop or delay process conditions for testing.

### SUMMARY OF THE INVENTION

The present invention provides methods for monitoring column chromatography

without having to stop the production process. In other words, the present invention solves the prior art problem of difficulty in monitoring column quality and efficiency (i.e., column performance). The present invention is directed toward monitoring column performance in continuous process production scenarios without the need to stop the process, the need to add additional test specific steps to the process flow or add reagents specific for column testing purposes (such as pulse chemicals or reagents). In other words, column performance is monitored without interrupting the process.

The present invention solves this problem by monitoring phase changes of process parameters. Process parameters that may be monitored to monitor column performance by the present invention include, for example, but not limited to a) conductivity; b) pH; c) salt concentration; d) light absorption; e) fluorescence after excitation with light of a suitable wavelength; f) refractive index; g) electrochemical response; and h) mass spectrometry data. One or more process parameters may be monitored in any production process and for any column in the production process.

In one aspect of the present invention, the quality of the packed bed is made by measuring a change in a measurable parameter such a conductivity, light absorbance or pH. Thus, the present method of HETP frontal analysis consists of suddenly changing the solution flowing in the column in order to generate a step of the measured value. By using the frontal analysis on existing chromatography operations that generate those steps and repeating this analysis cycle after cycle, it is possible to monitor the quality of packing of the chromatography columns without interrupting the process. Moreover, the repetition of this analysis cycle after cycle allows one to ascertain the changes in column quality during the continuous process.

Process parameters may be monitored by the use of probes specific for the process parameter(s) being monitored. One or ordinary skill in the art will be able to select the appropriate probe for monitoring a specific process parameter.

Process parameters may be monitored manually, i.e., by a person observing and noting the reading off a probe or recording system. However, preferably, the process parameters are monitored automatically by a computer or computer system designed, programmed or adapted for monitoring said process parameters and recording values from the probes. In this way the observed and recorded values can be input into a program for analysis for determination as to if column quality is sufficient for another run or if the column needs to be cleaned or repacked.

The present invention contemplates a method of monitoring one or more chromatography columns being operated in continuous process mode for efficiency and quality, the method comprising: providing one or more chromatography columns used in continuous mode; detecting changes in one or more process parameters selected from the group consisting of pH, conductivity, salt concentration, light absorption, fluorescence after excitation with light of a suitable wavelength, refractive index, electrochemical response and mass spectrometry immediately before, during and directly after the exchange of one process fluid to another process fluid that differ in the one or more process parameters to generate process data; applying a curve smoothing filter to said process data to generate corrected process data; calculating the first derivative of said corrected process data to produce derivatized process data of said corrected process data; determine the HETP value and asymmetry of said derivatized data; comparing the HETP value and asymmetry to standardized values; wherein, if the HETP values and asymmetry fall within said standardized values the column is used for another process run.

The method further contemplates that the curve smoothing calculation is the Savitzky-Golay smoothing filter.

The method may still further contemplate that the column or columns have been used continuously for between 2 and 100 runs.

The method of claim 1, wherein said column or columns have been used continuously for between 5 and 50 runs.

The method may still further contemplate that the continuous process mode comprises

at least two but not more than five different columns in sequence.

The method may still further contemplate that the columns are selected from the group consisting of affinity, ion exchange, size exclusion, reverse phase, chiral, frontal and hydrophobic.

The method may still further contemplate that the each column is monitored for efficiency and quality.

The method may still further contemplate that the continuous process mode comprises multiple process steps, comprises at least two but not more than ten process steps in sequence and at least one process step comprises a chromatography column.

The method may still further contemplate that the standardized values are based on historic data using the same or substantially the same columns and process parameters.

The method may still further contemplate that the HETP values and asymmetry do not fall within said standardized values the column is regenerated.

The method may still further contemplate that the HETP values and asymmetry do not fall within said standardized values an operator is notified by an automatic system. In some embodiments the automatic system is an alarm system or other notification system. It is contemplated that there may be several parameters to these alarms. For example, 1) Enabled/Disabled; 2) Non critical level-high/low, which may trigger a buzzer and display a non-critical alarm; 3) Critical alarm-High/Low which stops the process, but operators have to acknowledge and may restart the process, for example, to complete a process run.

### DESCRIPTION OF THE FIGURES

FIG. 1 shows a representative curve generated after pulse analysis of a chromatography column.

FIGS. 2A & B. FIG. 2A shows graphical representation of a step of measured value generated by a buffer change in a chromatography column. FIG. 2B shows the resultant curve after the post-column conductivity points are smoothed and derivated.

FIG. 3 shows a representative graph of conductivity generated during the various stages of a column run. The area where HETP frontal analysis is performed in denoted.

FIG. 4 shows HETP values generated for three columns over multiple cycles. The solid horizontal lines exemplify the recommended acceptable ranges of HETP for these runs. The peak at cycle 4 is where the process of continuous chromatography was interrupted for demonstration purposes.

FIG. 5 shows an example of asymmetry data generated by three columns where is the columns are clearly out of recommended values. The solid horizontal lines exemplify the recommended acceptable ranges of asymmetry for these runs. The peak at cycle 4 is where the process of continuous chromatography was interrupted for demonstration purposes.

FIG. 6 shows post-column conductivity at various time points.

FIG. 7 shows the same data as FIG. 6 after smoothing with smoothing factors (sf) of 2, 3, 6 and 9.

FIG. 8 shows the same data as FIGS. 6 & 7 after derivation.

FIG. 9 shows a plot of HETP (Y1-axis) and quantity of the eluate collected (Y2-axis) for column 1 over 12 cycles (X-axis).

FIG. 10 shows a plot of asymmetry (Y-axis) for column 1 for 12 cycles (X-axis).

FIG. 11 shows a plot of HETP (Y1-axis) and quantity of the eluate collected (Y2-axis) for column 2 over 12 cycles (X-axis).

FIG. 12 shows a plot of asymmetry (Y-axis) for column 2 for 12 cycles (X-axis).

FIG. 13 shows a plot of HETP (Y1-axis) and quantity of the eluate collected (Y2-axis) for column 3 over 12 cycles (X-axis).

FIG. 14 shows a plot of asymmetry (Y-axis) for column 3 for 12 cycles (X-axis).

### DETAILED DESCRIPTION OF THE INVENTION

### Definitions

The term “chromatography,” as used herein, refers to any kind of technique which separates an analyte of interest (e.g., a target molecule) from other molecules present in a mixture. Usually, the analyte of interest is separated from other molecules as a result of differences in rates at which the individual molecules of the mixture migrate through a stationary medium under the influence of a moving phase, or in bind and elute processes.

The term “chromatography resin” or “chromatography media” are used interchangeably herein and refer to any kind of phase (e.g., a solid phase) which separates an analyte of interest (e.g., a target molecule) from other molecules present in a mixture. Usually, the analyte of interest is separated from other molecules as a result of differences in rates at which the individual molecules of the mixture migrate through a stationary solid phase under the influence of a moving phase, or in bind and elute processes. Examples of various types of chromatography media include, for example, cation exchange resins, affinity resins, anion exchange resins, anion exchange membranes, hydrophobic interaction resins and ion exchange monoliths. Other chromatography media may be known to those or ordinary skill in the art at the time of filing this application and are included herein.

The term “capture step” as used herein, generally refers to a method used for binding a target molecule with a stimulus responsive polymer or a chromatography resin, which results in a solid phase containing a precipitate of the target molecule and the polymer or resin. Typically, the target molecule is subsequently recovered using an elution step, which removes the target molecule from the solid phase, thereby resulting in the separation of the target molecule from one or more impurities. In various embodiments, the capture step can be conducted using a chromatography media, such as a resin, membrane or monolith, or a polymer, such as a stimulus responsive polymer, polyelectrolyte or polymer which binds the target molecule.

The term “binding” as used herein to describe interactions between a target molecule (e.g., an Fc region containing protein) and a ligand attached to a matrix (e.g., Protein A bound to a solid phase matrix or resin), refers to the generally reversible binding of the target molecule to a ligand through the combined effects of spatial complementarity of e.g. protein and ligand structures at a binding site coupled with electrostatic forces, hydrogen bonding, hydrophobic forces, and/or van der Waals forces at the binding site. Generally, the greater the spatial complementarity and the stronger the other forces at the binding site, the greater will be the binding specificity of a protein for its respective ligand. Non-limiting examples of specific binding includes antibody-antigen binding, enzyme-substrate binding, enzyme-cofactor binding, metal ion chelation, DNA binding protein-DNA binding, regulatory protein-protein interactions, and the like. Ideally, in affinity chromatography specific binding occurs with an affinity of about 10⁻⁴ to 10⁻⁸ M in free solution.

The term “detergent” refers to ionic and nonionic surfactants such as polysorbates (e.g. polysorbates 20 or 80); poloxamers (e.g. poloxamer 188); Triton; sodium dodecyl sulfate (SDS); sodium laurel sulfate; sodium octyl glycoside; lauryl-, myristyl-, linoleyl-, or stearyl-sulfobetaine; lauryl-, myristyl-, linoleyl- or stearyl-sarcosine; linoleyl-, myristyl-, or cetyl-betaine; lauroamidopropyl-, cocamidopropyl-, linoleamidopropyl-, myristamidopropyl-, palmidopropyl-, or isostearamidopropyl-betaine (e.g. lauroamidopropyl); myristamidopropyl-, palmidopropyl-, or isostearamidopropyl-dimethylamine; sodium methyl cocoyl-, or disodium methyl oleyl-taurate; and the MONAQU AT™ series (Mona Industries, Inc., Paterson, N.J.), Useful detergents is a polysorbate, such as polysorbate 20 (TWEEN 20®) or polysorbate 80 (TWEEN 80®) or various acids, such as octanoic acid.

A “buffer” is a solution that resists changes in pH by the action of its acid-base conjugate components. Various buffers which can be employed depending, for example, on the desired pH of the buffer are described in: Buffers. A Guide for the Preparation and Use of Buffers in Biological Systems, Gueffroy, D., ed. Calbiochem Corporation (1975). Non-limiting examples of buffers include MES, MOPS, MOPSO, Tris, HEPES, phosphate, acetate, citrate, succinate, and ammonium buffers, as well as combinations of these.

According to the present invention the term “buffer” or “solvent” is used for any liquid composition that is used to load, wash, elute and reequilibrate the separation units.

When “loading” a separation column a buffer is used to load the sample or composition comprising the target molecule (e.g., an Fc region containing target protein) and one or more impurities onto a chromatography column (e.g., an affinity column or an ion exchange column). The buffer has a conductivity and/or pH such that the target molecule is bound to the chromatography matrix while ideally all the impurities are not bound and flow through the column.

When “loading” a separation column to “flow through” a target molecule a buffer is used to load the sample or composition comprising the target molecule (e.g., an Fc region containing target protein) and one or more impurities onto a chromatography column (e.g., an affinity column or an ion exchange column). The buffer has a conductivity and/or pH such that the target molecule is not bound to the chromatography matrix and flow through to column while ideally all the impurities are bound the column.

The term “reequilibrating” refers to the use of a buffer to re-equilibrate the chromatography matrix prior to loading the target molecule. Typically, the loading buffer is used for reequilibrating.

By “wash” or “washing” a chromatography matrix is meant passing an appropriate liquid, e.g., a buffer through or over the matrix. Typically washing is used to remove weakly bound contaminants from the matrix prior to eluting the target molecule and/or to remove non-bound or weakly bound target molecule after loading.

The term “affinity chromatography matrix,” as used herein, refers to a chromatography matrix which carries ligands suitable for affinity chromatography. Typically, the ligand (e.g., Protein A or a functional variant or fragment thereof) is covalently attached to a chromatography matrix material and is accessible to the target molecule in solution as the solution contacts the chromatography matrix. One example of an affinity chromatography matrix is a Protein A matrix. An affinity chromatography matrix typically binds the target molecules with high specificity based on a lock/key mechanism such as antigen/antibody or enzyme/receptor binding. Examples of affinity matrices are matrices carrying protein A ligands like Protein A SEPHAROSE™, PROSEPO-A, ESHMUNO® A and ESHMUNO® P (all available from MilliporeSigma, St. Louis, MO). In the processes and systems described herein, an affinity chromatography step may be used as the bind and elute chromatography step in the entire purification process.

The terms “ion-exchange” and “ion-exchange chromatography,” as used herein, refer to the chromatographic process in which a solute or analyte of interest (e.g., a target molecule being purified) in a mixture, interacts with a charged compound linked (such as by covalent attachment) to a solid phase ion exchange material, such that the solute or analyte of interest interacts non-specifically with the charged compound more or less than solute impurities or contaminants in the mixture. The contaminating solutes in the mixture elute from a column of the ion exchange material faster or slower than the solute of interest or are bound to or excluded from the resin relative to the solute of interest.

“lon-exchange chromatography” specifically includes cation exchange, anion exchange, and mixed mode ion exchange chromatography. For example, cation exchange chromatography can bind the target molecule (e.g., an Fc region containing target protein) followed by elution (e.g., using cation exchange bind and elute chromatography or “CIEX” or “CEX”) or can predominately bind the impurities while the target molecule “flows through” the column (cation exchange flow through chromatography FT-CEX). Anion exchange chromatography can bind the target molecule (e.g., an Fc region containing target protein) followed by elution or can predominately bind the impurities while the target molecule “flows through” the column, also referred to as negative chromatography. In some embodiments and as demonstrated in the Examples set forth herein, the anion exchange chromatography step is performed in a flow through mode.

The term “ion exchange matrix” refers to a matrix that is negatively charged (i.e., a cation exchange media) or positively charged (i.e., an anion exchange media). The charge may be provided by attaching one or more charged ligands to the matrix, e.g., by covalent linkage. Alternatively, or in addition, the charge may be an inherent property of the matrix (e.g., as is the case of silica, which has an overall negative charge).

Mixed mode anion exchange materials typically have anion exchange groups and hydrophobic moieties. Suitable mixed mode anion exchange materials are CAPTO® Adhere (GE Healthcare, Woburn, MA).

The term “anion exchange matrix” is used herein to refer to a matrix which is positively charged, e.g., having one or more positively charged ligands, such as quaternary amino groups, attached thereto. Commercially available anion exchange resins include DEAE cellulose, QAE SEPHADEX™ and FAST Q SEPHAROSE™ (GE Healthcare). Other exemplary materials that may be used in the processes and systems described herein are FRACTOGEL® EMD TMAE, FRACTOGEL® EMD TMAE HIGHCAP, ESHMUNO® Q and FRACTOGEL® EMD DEAE (MilliporeSigma, Burlington, MA).

The term “cation exchange matrix” refers to a matrix which is negatively charged, and which has free cations for exchange with cations in an aqueous solution contacted with the solid phase of the matrix. A negatively charged ligand attached to the solid phase to form the cation exchange matrix or resin may, for example, be a carboxylate or sulfonate. Commercially available cation exchange matrices include carboxy-methyl-cellulose, sulphopropyl (SP) immobilized on agarose (e.g., SP-SEPHAROSE FAST FLOW™ or SP-SEPHAROSE HIGH PERFORMANCE™, from GE Healthcare) and sulphonyl immobilized on agarose (e.g., S-SEPHAROSE FAST FLOW™ from GE Healthcare). Preferred is FRACTOGEL® EMD SO3, FRACTOGEL® EMD SE HIGHCAP, ESHMUNO® S, ESHMUNO® CP-FT, ESHMUNO® CPX and FRACTOGEL® EMD COO (MilliporeSigma).

The term “regeneration” when applied herein to column regeneration shall mean treatment of a column to remove contaminants that are tightly bound to the chromatography resin. One of skill in the art knows how to regenerate a chromatography column. Various methods are feasible for cleaning chromatographic media. Chemical stability of the material and the type of contamination is taken into consideration. Organic solvents, bases and acids are often used. Polymeric matrices are characterized by higher chemical stability than inorganic sorbents based on silica gels which can be instable in the presence of NaOH or other alkali. They can also withstand treatment with acids in contrast to media based on carbohydrates.

Lipids or similar substance (e.g., lipoproteins) can be removed with organic solvents like ethanol, isopropanol or ethylene glycol. Denatured proteins can be effectively removed with sodium hydroxide (0.1 N up to 1.0 N NaOH).

If contaminants are tightly bound, it may be necessary to regenerate the column material with an acidic pepsin solution (e.g., 0.1% pepsin in 0.01 N HCL), 6 M guanidine hydrochloride or diluted sodium lauroyl sarcosinsate (SLS) solution (2% SLS in 0.25 M NaCl). SLS may then be removed with 20% 2-propanol in 0.01 N HCL.

The term “equilibrium buffer” refers to a solution or reagent used to neutralize conditions or otherwise bias target molecules to effectively interact with a ligand within a chromatography column or bioreactor. For example, buffer solutions described herein are capable of keeping the pH of biological systems nearly constant while chemical changes are occurring. In some examples according to embodiments of the disclosure, the pH is maintained by the equilibrium buffer nearly constant despite the biological systems having a pH between, for example, 7.0 to 10.0.

The term “elution buffer” refers to a buffer or reagent used to take off or elute product that is bound to a chromatographic media. For example, an elution buffer may be capable of eluting empty AAV (adeno-associated virus) particles during a first elution and full AAV particles during a second elution, thereby allowing the concentration of full AAV particles.

The term “effluent” refers to a component that is mobile, i.e., leaving, during chromatography processes, a.k.a., an eluate, e.g., using constant composition of elution buffer without increasing or decreasing buffer composition.

The term “isocratic elution conditions” refers to a condition of constant composition of elution buffer during chromatography processes.

The term “gradient elution conditions” refers to a condition of varying composition of elution buffer during chromatography processes, e.g., forming a gradient of elution buffer from 0-100% buffer in a specific time and/or during a plurality of column volumes.

Chromatography can be operated in any of three modes: (1) batch mode, where the media is loaded with target protein, loading is stopped, media is washed and eluted, and the pool is collected; (2) semi-continuous mode, where the loading is performed continuously, while the elution is intermittent (e.g., in case of continuous multicolumn chromatography); and (3) full “continuous mode,” where both loading and elution are performed continuously. U.S. patent application US 2013/0280788 (incorporated herein in its entirety) describes embodiments of what is referred to as a continuous chromatography method and apparatus, employing several chromatography columns in turn and sequentially. Continuous chromatography can be part of a “continuous process” purification procedure or operation.

The term “continuous process” or “contiguous process,” as used interchangeably herein, refers to a process for purifying a target molecule, which includes two or more process steps (or unit operations), such that the output from one process step flows directly into the next process step in the process, without interruption, and where two or more process steps can be performed concurrently for at least a portion of their duration. In other words, in case of a continuous process, as described herein, it is not necessary to complete a process step before the next process step is started, but a portion of the sample is always moving through the process steps. The term “continuous process” also applies to steps within a process step, in which case, during the performance of a process step including multiple steps, the sample flows continuously through the multiple steps that are necessary to perform the process step. One example of such a process step described herein is the flow through purification step which includes multiple steps that are performed in a continuous manner, e.g., flow-through activated carbon followed by flow-through AEX media followed by flow-through CEX media followed by flow-through virus filtration.

The term “semi-continuous process,” as used herein, refers to a generally continuous process for purifying a target molecule, where input of the fluid material in any single process step or the output is discontinuous or intermittent. For example, in some embodiments according to the present invention, the input in a process step (e.g., a bind and elute chromatography step) may be loaded continuously; however, the output may be collected intermittently (for example, in a surge tank or pool tank), where the other process steps in the purification process are continuous. Accordingly, in some embodiments, the processes and systems described herein are “semi-continuous” in nature, in that they include at least one unit operation which is operated in an intermittent matter, whereas the other unit operations in the process or system may be operated in a continuous manner.

The term “connected process” refers to a process for purifying a target molecule, where the process comprises two or more process steps (or unit operations), which are in direct fluid communication with each other, such that fluid material continuously flows through the process step in the process and is in simultaneous contact with two or more process steps during the normal operation of the process. It is understood that at times, at least one process step in the process may be temporarily isolated from the other process steps by a barrier such as a valve in the closed position. This temporary isolation of individual process steps may be necessary, for example, during start up or shut down of the process or during removal/replacement of individual unit operations. The term “connected process” also applies to steps within a process step, e.g., when a process step requires several steps to be performed in order to achieve the intended result of the process step. One such example is the flow-through purification process step, as described herein, which may include several steps to be performed in a flow-through mode, e.g., activated carbon, anion exchange chromatography, cation exchange chromatography and virus filtration.

The term “fluid communication,” as used herein, refers to the flow of fluid material between two process steps or flow of fluid material between steps of a process step, where the process steps are connected by any suitable means (e.g., a connecting line or surge tank), thereby to enable the flow of fluid from one process step to another process step. In some embodiments, a connecting line between two-unit operations may be interrupted by one or more valves to control the flow of fluid through the connecting line.

The terms “purifying,” “purification,” “separate,” “separating,” “separation,” “isolate,” “isolating” or “isolation,” as used herein, refer to increasing the degree of purity of a target molecule from a sample comprising the target molecule and one or more impurities. Typically, the degree of purity of the target molecule is increased by removing (completely or partially) at least one impurity from the sample. In some embodiments, the degree of purity of the target molecule in a sample is increased by removing (completely or partially) one or more impurities from the sample by using, e.g., a chromatography process, as described herein. In another embodiment, the degree of purity of the target molecule in a sample is increased by precipitating the target molecule away from one or more impurities in the sample. The term “pI” or “isoelectric point” of a polypeptide, as used interchangeably herein, refers to the pH at which the polypeptide's positive charge balances its negative charge. pI can be calculated from the net charge of the amino acid residues or sialic acid residues of attached carbohydrates of the polypeptide or can be determined by isoelectric focusing.

The term “pH” is known in the art to refer to a measure of hydrogen ion concentration in a liquid. It is a measure of the acidity or alkalinity of a solution. The equation for calculating pH was proposed in 1909 by Danish biochemist Søren Peter Lauritz Sørensen:

$$pH = - log [ H + ]$$

where log is the base-10 logarithm and [H+] stands for the hydrogen ion concentration in units of moles per liter solution. The term “pH” comes from the German word “potenz,” which means “power,” combined with H, the element symbol for hydrogen, so pH is an abbreviation for “power of hydrogen.”

The term “process parameter,” as used herein as conditions used in a purification

process. These process parameters may be monitored with, for example, one or more sensors and/or probes. Examples of process parameters are temperature, pressure, pH, conductivity, dissolved oxygen (DO), dissolved carbon dioxide (DCO₂), mixing rate and flow rate. The sensor may also be an optical sensor in some cases. The sensor may be connected to an automatic control system for adjusting a process parameter.

The term “conductivity,” as used herein, refers to the ability of an aqueous solution to conduct an electric current between two electrodes. In solution, the current flows by ion transport. Therefore, with an increasing amount of ions present in the aqueous solution, the solution will have a higher conductivity. The unit of measurement for conductivity is milliSeimens per centimeter (mS/cm or mS), and can be measured using a commercially available conductivity meter (e.g., sold by Orion, OPTEX AND KNAUER). The conductivity of a solution may be altered by changing the concentration of ions therein. For example, the concentration of a buffering agent and/or concentration of a salt (e.g., NaCl or KCl) in the solution may be altered in order to achieve the desired conductivity. In some embodiments, the salt concentration of the various buffers is modified to achieve the desired conductivity. In some embodiments, in processes where one or more additives are added to a sample load, if one or more wash steps are subsequently used, such wash steps employ a buffer with a conductivity of about 20 mS/cm or less.

The term “salt,” as used herein, refers to a compound formed by the interaction of an acid and a base. Various salts which may be used in various buffers employed in the methods described herein include, but are not limited to, acetate (e.g., sodium acetate), citrate (e.g., sodium citrate), chloride (e.g., sodium chloride), sulphate (e.g., sodium sulphate), or a potassium salt.

The terms “bind and elute mode” and “bind and elute process,” as used herein, refer to a separation technique in which at least one target molecule contained in a sample (e.g., an Fc region containing protein) binds to a suitable resin or media (e.g., an affinity chromatography media or a cation exchange chromatography media) and is subsequently eluted.

The terms “flow-through process,” “flow-through mode” and “flow-through operation,” as used interchangeably herein, refer to a separation technique in which at least one target molecule (e.g., an Fc-region containing protein or an antibody) contained in a biopharmaceutical preparation along with one or more impurities is intended to flow through a material, which usually binds the one or more impurities, where the target molecule usually does not bind (i.e., flows through).

The term ‘breakthrough” refers to the volume at which a particular solute pumped continuously through a column begins to elute. The breakthrough volume is useful in determining the total sample capacity of the column for a particular solute.

The term “effective breakthrough” is measured with the absorbance at 280 nm of the solution flowing at the outlet of the column by subtracting it from the absorbance measured during the plateau of impurities measured before any breakthrough of a target protein (e.g., Immunoglobulin G) and dividing it by the difference between the offline measure of the absorbance at 280 nm of the feed and the absorbance at 280 nm of the plateau of impurities.

The term “process step” or “unit operation,” as used interchangeably herein, refers to the use of one or more methods or devices to achieve a certain result in a purification process. Examples of process steps or unit operations which may be employed in the processes and systems described herein include, but are not limited to, clarification, bind and elute chromatography, virus inactivation, flow-through purification and formulation. It is understood that each of the process steps or unit operations may employ more than one step or method or device to achieve the intended result of that process step or unit operation. For example, in some embodiments, the clarification step and/or the flow-through purification step, as described herein, may employ more than one step or method or device to achieve that process step or unit operation. In some embodiments, one or more devices which are used to perform a process step or unit operation are single-use devices and can be removed and/or replaced without having to replace any other devices in the process or even having to stop a process run.

The term “surge tank” as used herein refers to any container or vessel or bag, which is used between process steps or within a process step (e.g., when a single process step comprises more than one step); where the output from one step flows through the surge tank onto the next step. Accordingly, a surge tank is different from a pool tank, in that it is not intended to hold or collect the entire volume of output from a step; but instead enables continuous flow of output from one step to the next. In some embodiments, the volume of a surge tank used between two process steps or within a process step in a process or system described herein, is no more than 25% of the entire volume of the output from the process step. In another embodiment, the volume of a surge tank is no more than 10% of the entire volume of the output from a process step. In some other embodiments, the volume of a surge tank is less than 35%, or less than 30%, or less than 25%, or less than 20%, or less than 15%, or less than 10% of the entire volume of a cell culture in a bioreactor, which constitutes the starting material from which a target molecule is to be purified.

The term “static mixer” refers to a device for mixing two fluid materials, typically liquids. The device generally consists of mixer elements contained in a cylindrical (tube) housing. The overall system design incorporates a method for delivering two streams of fluids into the static mixer. As the streams move through the mixer, the non-moving elements continuously blend the materials. Complete mixing depends on many variables including the properties of the fluids, inner diameter of the tube, number of mixer elements and their design etc.

The term “standardized value(s)” or “accepted value(s)” refers to a value or range of values accepted by one of ordinary skill in the art in a field for a specific process or procedure parameter. Values outside the standardized value(s) indicate that the process or procedure is not operating efficiently and process parameters or process components may need to be adjusted, cleaned or replaced. For example, as related to the immediate invention, if process parameters are outside the standard or accepted values for an efficient chromatography column run, the chromatography column is regenerated, cleaned or replaced. Standardized values may be selected from one or more of, for example, pH, temperature, conductivity, salt concentration, light absorption, fluorescence after excitation with light of a suitable wavelength, refractive index, electrochemical response and mass spectrometry. A value may be measured at any time during the chromatography run including, but not limited to, immediately before, during and directly after the exchange of one process fluid to another process fluid that differ in the one or more process parameters to generate process data (i.e., process value(s)), said process data compared to values deemed standard (standard values) for that parameter for the chromatography run being processed. One of ordinary skill in the art will be able to determine the standardized value(s) for any particular chromatography column and process parameter.

### Height Equivalent of a Theoretical Plate

Height Equivalent of a Theoretical Plate (HETP) is a modeling system used to evaluate column effectiveness and efficiency. The HETP model helps users to design and evaluate chromatography columns in order to optimize the column. The goal is to obtain minimal or limited broadening of the column effluent peaks. The HETP model divides the chromatographic column into theoretical layers called plates. Separate equilibrations of the sample between stationary and mobile phases occur in the “plates.” The higher the plates number (N), the better the separation will be. If a column is properly packed, it will have a “good” number of plates and, thus, a small HETP. A column with a relatively high number of plates will have sharper column peaks than a similar column with a lower number of peaks.

$$H E T P = L / N$$

So, HETP describes the broadness of the Gaussian curve. For a well packed column, the HETPs will be in the range of 3-6 times the average particle diameter. For example, for 75 um beads, the HETP target is 0.0225 to 0.045 cm.

Asymmetry is another factor that can affect column effectiveness and efficiency. In an ideal column run, the leading half of a column peak should be the mirror image to the trailing half of the column peak. In other words, one half should not “trail off” any more than the other half. Asymmetry is calculated as:

$${A}_{S} = b / a$$

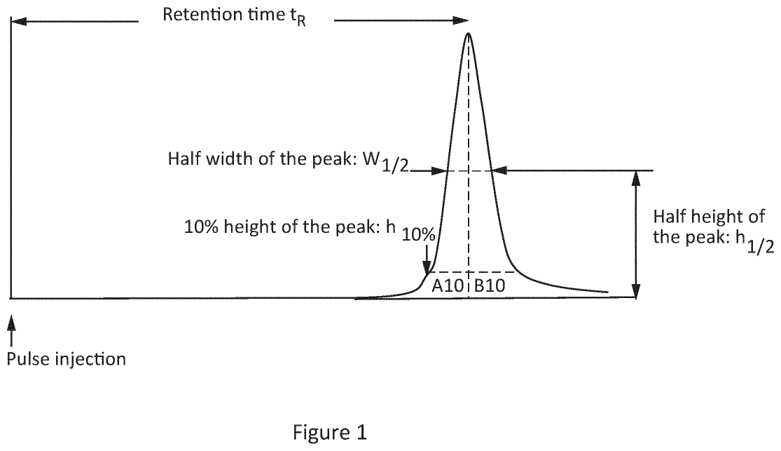

FIG. 1 shows a representative column peak with a degree of asymmetry.

So, asymmetry describes the deviation of the peak shape from an ideal Gaussian curve. A good working range is 0.8-1.8 but this range can be further refined based on column length. For long beds a good working range is 0.8-1.5 and for short beds a good working range is 0.7-1.8.

### Pulse Analysis

The HETP pulse analysis is generally achieved by injecting a small quantity of an inert tracer which would be monitored by absorbance or conductivity measurement and would be displayed theoretically as a pulse of infinitely short duration (dt) and infinitely high value (yₘₐₓ=1/dt). The flowing of this pulse of tracer through the packed bed without any other interaction than flowing through porous media, result in the display after the column of a peak with a Gaussian shape. The analysis of this Gaussian curve gives the value of the HETP and the Asymmetry with the following formula:

$$H E T P = \frac{B H}{5.54 \times {( \frac{{t}_{R}}{{w}_{1 / 2}} )}^{2}}$$

where BH is the bed height, t_{R} is the retention time that can be determined with the duration between the time of injection of the tracer and the time of the display of the maximum peak height. W_{1/2} is the width of the peak at the half of the maximum height of the peak. See, FIG. 1. A10 and B10 are the duration between the times reaching 10% of the maximum and the maximum of peak height. Smaller HETP values and Asymmetry close to 1 are signs of good quality of packing of the chromatography media in the column.

### Frontal Analysis

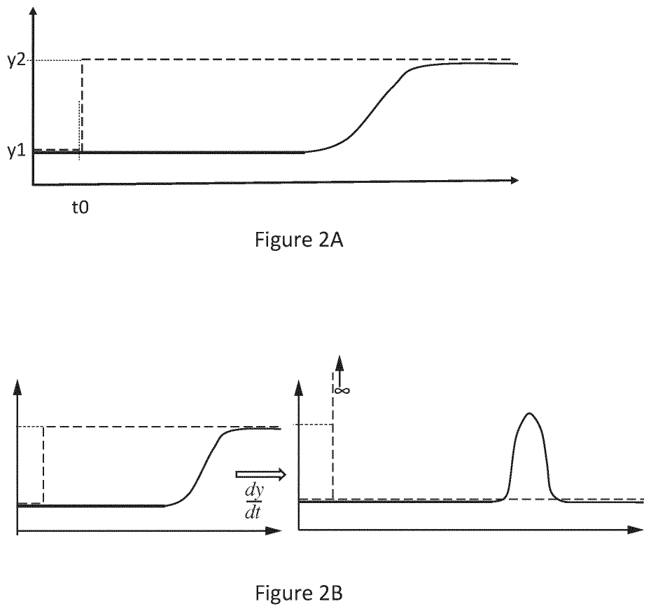

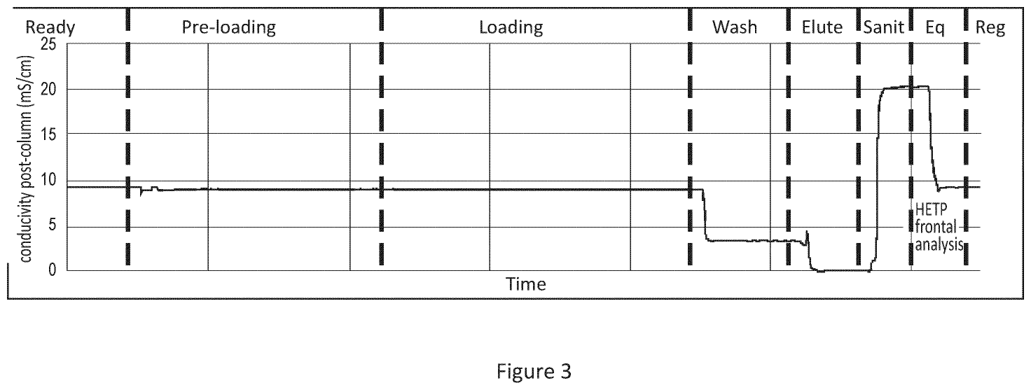

Another method, the HETP frontal analysis consists of suddenly changing the buffer flowing in the column in order to generate a step of the measured value. This step is theoretically the integration of the previously described pulse with the formula: when t<t₀ then y=y₁ and when t>t₀ then y=y₂ with (y₂−y₁) being the height of the step. The flowing of this step through the column results theoretically in a curve being the integral of a Gaussian curve. By derivation of this curve, we can obtain a similar peak with a Gaussian shape to obtain the HETP and Asymmetry values. See, FIGS. 2A & B. FIG. 3 shows a representative graph of conductivity generated during the various stages of a column run. An area where HETP frontal analysis can be performed is denoted.

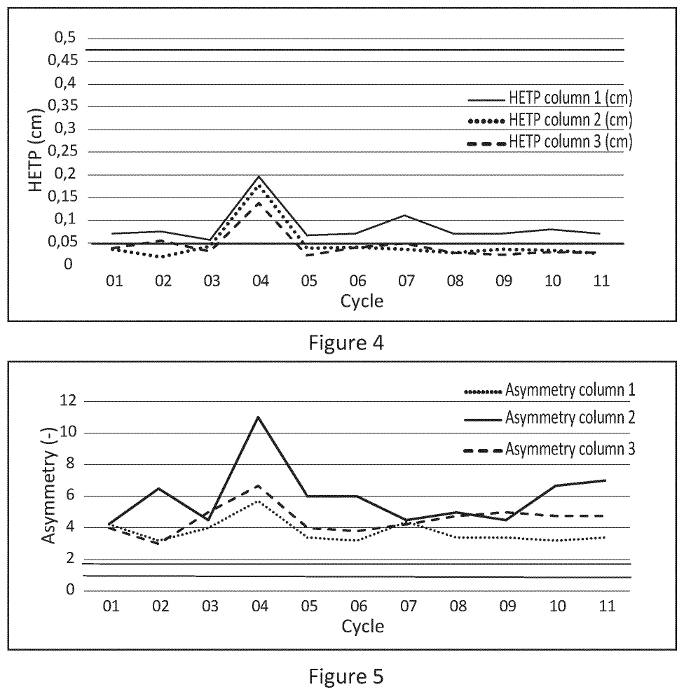

This method gives the quality of packing of the chromatography resins at the end of every cycle of the continuous chromatography operation without stopping the continuous chromatography operation. We displayed in FIG. 4 the values of HETP per column and cycle after cycle that are in range. We display in FIG. 5 the values of asymmetry per column and cycle after cycle that, in contrast to the HEPT values of FIG. 4, are out of range. The solid horizontal lines indicate exemplary ranges of recommended HETP and Asymmetry (acceptable values). Acceptable values may differ based on the specific column parameters. One of ordinary skill in the art will be able to determine acceptable HETP and asymmetry parameters for a particular column run with the teachings provided by this specification. Typically, for a well packed column, the HETPs will be in the range of 3-6 times the average particle diameter. For example, for 75 μm beads, the HETP target is 0.0225 to 0.045 cm.

A good working range of asymmetry is 0.8-1.8 but this range can be further refined based on column length. For long beds a good working range is 0.8-1.5 and for short beds a good working range is 0.7-1.8.

### Smoothing Filters

Smoothing filters are mathematical formulas or algorithms used in statistics, image processing and data processing to smooth a data set is to create an approximating function that attempts to capture important patterns in the data, while leaving out noise or other fine-scale structures/rapid phenomena. In smoothing, the data points of a signal are modified so individual points higher than the adjacent points (presumably because of noise) are reduced, and points that are lower than the adjacent points are increased leading to a smoother signal. In other words, the purpose of these filters is to smooth noisy data without reducing signal intensity.

There are many specific smoothing filters known in the art, each with its advantages and disadvantages for various different uses. Most use a “moving average” analysis. With a moving average analysis, each data point is replaced by a local average of the surrounding data points. The algorithm may implement a weighted or unweighted smoothing function. A weighted average give greater weight to the median value being analyzed whereas an unweighted average, as the name suggests, gives equal weight to all values being analyzed.

The choice of deciding to use one algorithm over another for a particular use may need to be determined by empirical means, especially if the use is new, unconventional or untested. Further still, alternatives to smoothing filters exist in the art including, for example, Weiner filtering (en.wikipedia.org/wiki/Wiener_filter) or using the raw unsmoothed data.

While not specifically limited, in a preferred embodiment the present invention makes use of the Savitzky-Golay filter. Savitzky A., and Golay, M. J. E. 1964, Analytical Chemistry, vol. 36, pp. 1627-1639. The Savitzky-Golay filter is a low-pass filter. A low pass filter works essentially by filtering out everything but the low-frequency signal. Effectively, this “smooths” out the data by taking out “jittery,” high-frequency noise.

### Continuous Chromatography

In continuous chromatography, several identical columns are typically connected in an arrangement that allows columns to be operated in series and/or in parallel, depending on the method requirements. Thus, all columns can be run simultaneously or may overlap intermittently in their operation. Each column is typically loaded, eluted, and regenerated several times during a process run. Compared to conventional chromatography, where a single chromatography cycle is based on several consecutive steps, such as loading, washing, elution and regeneration, in case of continuous chromatography based on multiple identical columns, all these steps may occur on different columns. Accordingly, continuous chromatography operation may result in a better utilization of chromatography resin and reduced buffer requirements, which benefits process economy.

Exemplary continuous chromatography processes which may be used in the bind and elute chromatography or sizing chromatography process steps can be found, e.g., in European Patent Application Nos. EP11008021.5 (US 2014/0251911) and EP12002828.7 (US 2020/0101399), both incorporated by reference. Also, U.S. Pat. No. 9,149,738 (incorporated herein in its entirety) describes a continuous chromatography method and apparatus, employing several chromatography columns in turn and sequentially. Continuous chromatography may be applied to any type or types of chromatography known in the art.

### Exemplification

### HETP Demonstrated in Continuous Chromatography Procedure

To demonstrate the benefit of such analytical method, we performed the capture of Immunoglobin G at 4 g/L by preparing it in a TRIS buffer at 0.05 mol/L and adjusted at pH =6.5. We used 3 QuikScale (Milliporeigma, Bedfor, MA) chromatography columns of internal diameter 200 mm that were packed with the Protein A affinity chromatography resin called Eshmuno® A from Merck KGaA with a bed height of 9.8 mm for a total column volume of 3.079 L. Each column had been tested with the HETP pulse analysis method using a pulse of acetone 2% w/w in a buffer of NaCl 0.3M with a linear velocity of 150 cm/h. The acetone pulse volume was 2% of the column volume. The test had been performed with the CoPrime® Biochromatography (MilliporeSigma) system and the HETP pulse analysis was calculated with the report generator of its software Common Control Platform® developed by Merck KGgA. Results for column 1 were HETP=0.0183 cm and Asymmetry=1.692, for column 2 were HETP=0.0145 cm and Asymmetry=1.783, for column 3 were HETP=0.0337 cm and Asymmetry=1.333.

The Multi-Column-Capture system used for this demonstration allows to load at 294 cm/h on 2 columns in series while the third column performs the non-loading step. The first column is the loading column directly supplied to its inlet with Immunoglobulin G by a first pump. While the first column is loaded, a portion of the Immunoglobulin G binds to the protein A resin Eshumno® A. The oulet of the first column is directly connected to the second column which is the pre-loading column. The second column receives the material not bound to the first column, being impurities but also Immunoglobulin G not bound to the protein A resin of the first column. The outlet of the second column goes to waste. As the loading is happening, the protein A sites of the resin will be bound to captured Immunoglobulin G. The saturation of the binding sites will follow a gradient from the inlet to the outlet of the first column, the inlet being saturated first with bound Immunoglobulin G, while binding sites near the outlet may not be saturated. However, as the binding site near the end of the column became more and more saturated, the binding sites became loaded and excess Immunoglobulin G broke through the column.

In a traditional batch approach involving only one column, loss of product is avoided by stopping the process before product breaking through. This is done by stopping column loading at 90% of the volume estimated to get a 10% breakthrough meaning that the concentration in product at the outlet of the column is 10% of the concentration at the inlet. Thus in a traditional approach, the gradient of bound protein A sites from inlet to outlet leads to fewer used binding sites the closer to the outlet. The goal of the continuous chromatography is to over-saturate the first column up to 60% or 70% and feed the column flowthrough to a second column to capture the Immunoglobulin G breaking through the first column. This results in a more efficient use of the protein A resin of the first column.

The second column is considered as in pre-loading because it captures Immunoglobulin G at lower inlet concentration between 0% and 60-70% of the feed concentration. The product and impurities concentration is estimated using absorbance measured at 280 nm. During the start of the loading, before any breakthrough of unbound product, impurities with no Fc sites that are able to bind to protein A flow through and exit the column first. The absorbance at 280 nm of these impurities is called the impurity plateau and corresponds to a 0% breakthrough. In contrast, an offline absorbance at 280 nm measurement of the feed of Immunoglobulin G prior to loading the first column gives the value for a 100% breakthrough. The effective breakthrough is measured with the absorbance at 280 nm of the solution flowing at the outlet of the column by subtracting it from the absorbance measured during the plateau of impurities measured before any breakthrough of Immunoglobulin G and dividing it by the difference between the offline measure of the absorbance at 280 nm of the feed and the absorbance at 280 nm of the plateau of impurities.

When the breakthrough level was reached, such as 60% or 70%, a set of 3-way valves were used to disconnect the first column from the feed pump and connect it to the buffer pump for non-loading steps. The outlet of the first column is disconnected from the second column and connected to a set of outlets such as waste or fraction collection. The inlet of the second column is connected to the feed pump. The second column becomes the loading column. The outlet of the second column is connected to the inlet of the third column which becomes the pre-loading column connected to waste. Non-loading steps of column 1 will have to be faster than the breakthrough of column 2. After the breakthrough on column 2, it is connected to buffer pump for non-loading steps. Column 3 becomes the loading column and its inlet of connected to the feed pump and the outlet of column 3 is connected to the inlet of column 1 which becomes the pre-loading column. After the breakthrough on column 3, a complete cycle is complete and the system starts a new cycle by connecting the inlet of column 1 to the feed pump and becoming for a new cycle the loading column, the outlet of column 1 is connected to the inlet of column 2 becoming again the pre-loading column and column 3 is connected to the buffer pump for non-loading steps. An additional advantage of the present invention is to never stop the feed pump and to have all the non-loading phases faster than the loading phase.

For our demonstration, the non-loading phase was executed at 430 cm/h. It was first composed of a washing of the column with TRIS 0.05 mol/L at pH=6.5 for 8 column volumes. Then an elution using acetic acid 0.1 mol/L at pH=3 and peak collection with 0.05 AU (Absorbance Unit. See, en.wikipedia.org/wiki/Absorbance #Absorbance_of_a_material) as peak start and end of collection followed by a sanitization step with NaOH 0.1 mol/L for 3 column volumes and an equilibration with TRIS 0.05 mol/L at pH=6.5 for 5 column volumes.

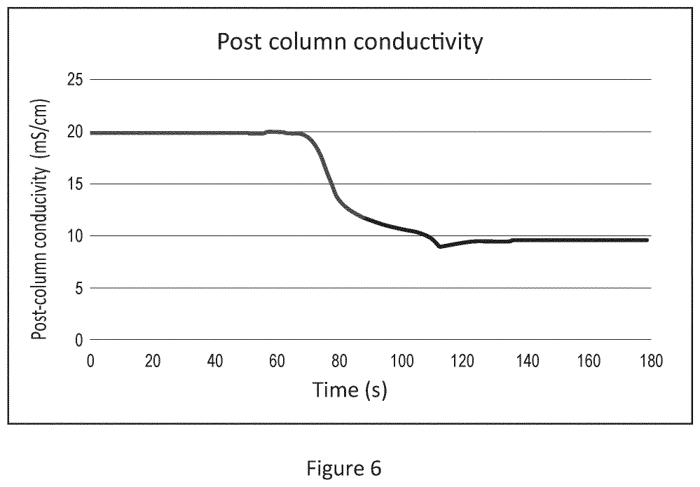

As this sequence of steps were run at every cycle for the non-loading phase of every column, it was possible to monitor the condition of the columns cycle after cycle. In our demonstration, we analyze the curve of the conductivity during equilibration as it dropped from the 20 mS/cm of NaCl 0.1 mol/L to the 9 mS/Cm of the TRIS buffer 0.05 mol/L at pH=6.5. We made a comparison with the determination of the residence time distribution (see, for example, en.wikipedia.org/wiki/Residence_time #Pulse_experiments and en.wikipedia.org/wiki/Residence_time #Biochemical) of the column. Consider the conductivity drop due to the switch from NaCl 0.1 mol/L to TRIS buffer 0.05 mol/L as a conductivity step experiment, which is the integral function of a pulse function (see, for example en.wikipedia.org/wiki/Laplace_transform #Table_of_selected_Laplace_transforms), thus the analogy between HETP pulse analysis and HETP frontal analysis. By derivation of the curve of the conductivity at the column outlet, we can obtain a similar curve than the one that could be obtained in pulse analysis. See, FIG. 6. As the least noise is disturbing the derivation of the conductivity curve, smoothing of this curve and derivation is necessary.

For the smoothing of the conductivity curve, we used the Savitzky-Golay Smoothing Filter with the formula:

$${y}_{t} = \frac{1}{{h}_{s f}} \times {Σ}_{i = - sf}^{i = + sf} {a}_{i} \times {c}_{t + i} .$$

In this formula, sf is the smoothing factor between 2 and 12; in figure bb we show sf 2, 3, 6 and 9. cₜ is the conductivity at the time t, Cₜ₊ᵢ is the conductivity at the time t plus the number i of the time interval between 2 points, which is 2 seconds in our demonstration and yₜ is the smoothed conductivity at the time t. aᵢ are the smoothing coefficients where aᵢ=a₋ᵢ and the values according the smoothing factor which are described in the table below. We observed that each point of the smoothed conductivity is the result of a moving average with inequal weight per points. The number of points used for this moving average is equal to 2sf+1 as it used the point cₜ at the time of the calculation, the sf points before this point and the sf points after this point.

TABLE 1

| smoothing | number | | | | | | | | | | | | | | |
|---|---|---|---|---|---|---|---|---|---|---|---|---|---|---|---|
| factor | of points | a0 | a1 | a2 | a3 | a4 | a5 | a6 | a7 | a8 | a9 | a10 | a11 | a12 | h |
| 2 | 5 | 17 | 12 | −3 | | | | | | | | | | | 35 |
| 3 | 7 | 7 | 6 | 3 | −2 | | | | | | | | | | 21 |
| 4 | 9 | 59 | 54 | 39 | 14 | −21 | | | | | | | | | 231 |
| 5 | 11 | 89 | 84 | 69 | 44 | 9 | −36 | | | | | | | | 429 |
| 6 | 13 | 25 | 24 | 21 | 16 | 9 | 0 | −11 | | | | | | | 143 |
| 7 | 15 | 167 | 162 | 147 | 122 | 87 | 42 | −13 | −78 | | | | | | 1105 |
| 8 | 17 | 43 | 42 | 39 | 34 | 27 | 18 | 7 | −6 | −21 | | | | | 323 |
| 9 | 19 | 269 | 264 | 249 | 224 | 189 | 144 | 89 | 24 | −51 | −136 | | | | 2261 |
| 10 | 21 | 329 | 324 | 309 | 284 | 249 | 204 | 149 | 84 | 9 | −76 | −171 | | | 3059 |
| 11 | 23 | 79 | 78 | 75 | 70 | 63 | 54 | 43 | 30 | 15 | −2 | −21 | −42 | | 805 |
| 12 | 25 | 467 | 462 | 447 | 422 | 387 | 343 | 287 | 222 | 147 | 62 | −33 | −138 | −253 | 5175 |

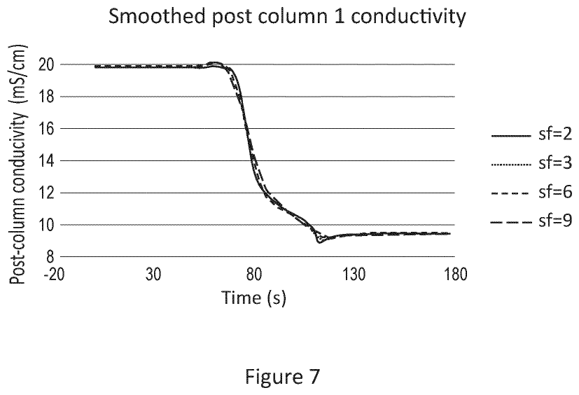

FIG. 7 shows the results on the column 3 during the equilibration of the non-loading phase of the 10^{th} cycle. We observe that the slight conductivity drop at 112 s has been smoothed.

To obtain the derivate of the conductivity, we once again used the Savitzky-Golay Smoothing Filter, but for first derivative with the formula:

$${y}_{t}^{′} = \frac{1}{{h}_{sf}^{′}} \times {Σ}_{i = - sf}^{i = + sf} i \times {c}_{t + i} .$$

In this formula, sf is the smoothing factor between 2 and 12, and in our demonstration we keep the same sf numbers: 2, 3, 6 and 9. cₜ is the conductivity at the time t, cₜ₊ᵢ is the conductivity at the time t plus the number i of the time interval between 2 points, which is 2 seconds is our demonstration and yₜ is the smoothed conductivity at the time t. The smoothing coefficients this time were aᵢ=i and thus aᵢ=−a₋ᵢ and a₀=0. The values of h′_{sf} according the smoothing factor are described in the table below. We observed that each point of the smoothed conductivity derivate curve is again the result of a moving average with inequal weight per points. The number of points used for this moving average was again equal to 2sf+1 as it used the point cₜ at the time of the calculation, the sf points before this point and the sf points after this point.

TABLE 2

| smoothing | number | |
|---|---|---|
| factor | of points | h |
| 2 | 5 | 10 |
| 3 | 7 | 28 |
| 4 | 9 | 60 |
| 5 | 11 | 110 |
| 6 | 13 | 182 |
| 7 | 15 | 280 |
| 8 | 17 | 408 |
| 9 | 19 | 570 |
| 10 | 21 | 770 |
| 11 | 23 | 1012 |
| 12 | 25 | 1300 |

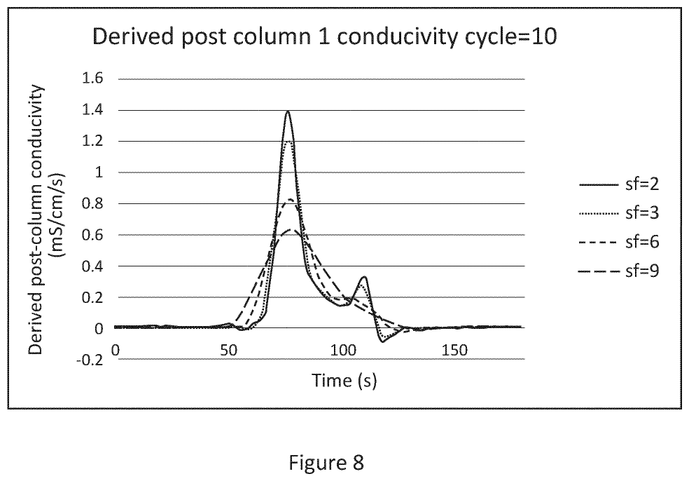

Shown in FIG. 8 are the results on column 3 during the equilibration of the non-loading phase of the 10th cycle. We observed that we obtained a Gaussian-like curve with a little asymmetry, very similar to a HETP pulse result function. Nevertheless, we observe that the more we smooth the curve, the broader it becomes and HETP becomes higher. As smoothing factor 2 is giving a curve without noise, we used this light smoothing of the conductivity curve.

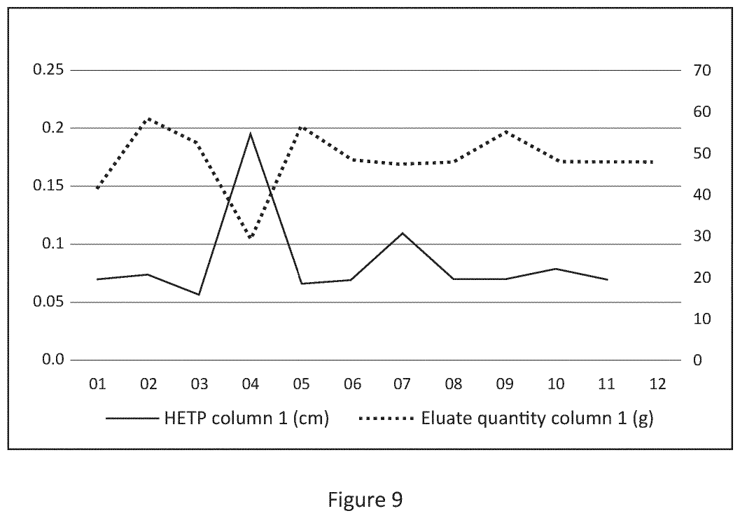

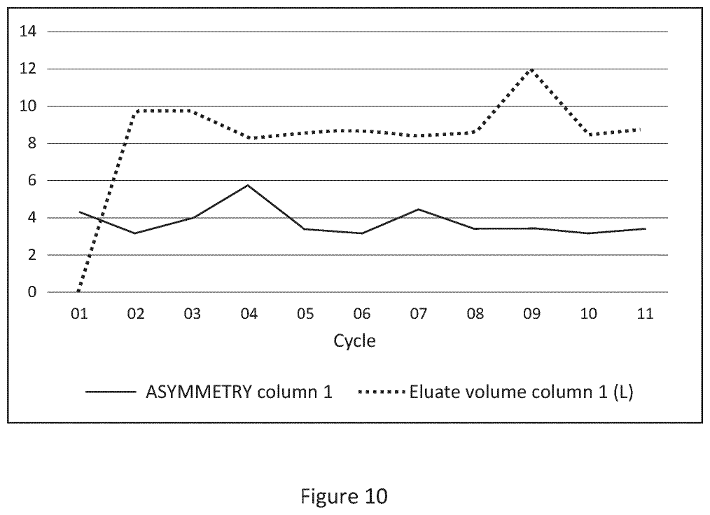

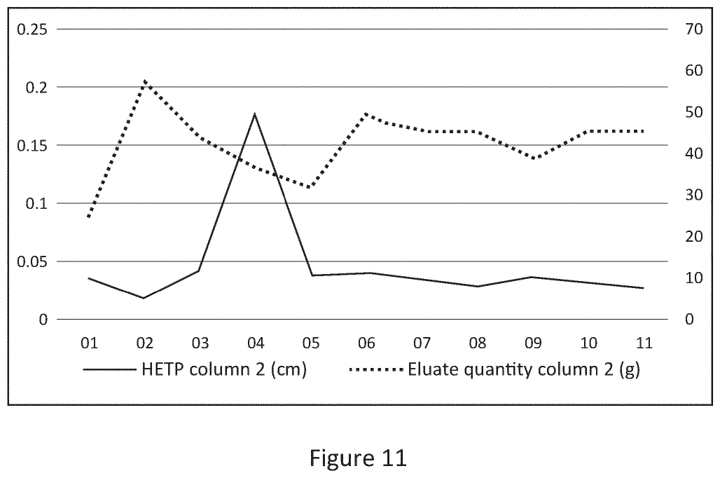

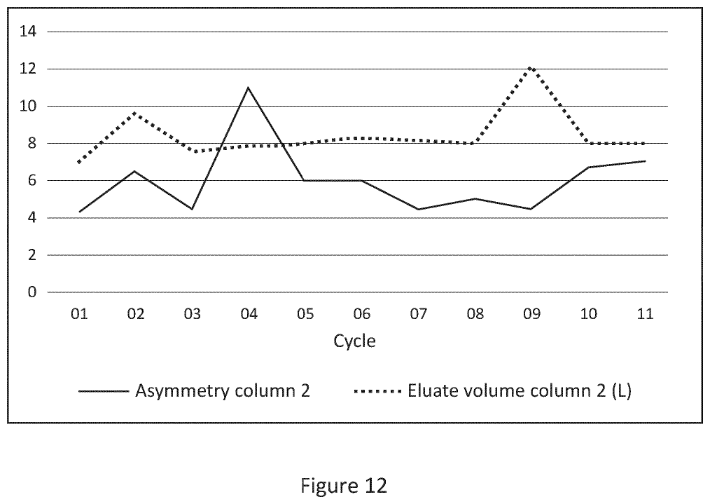

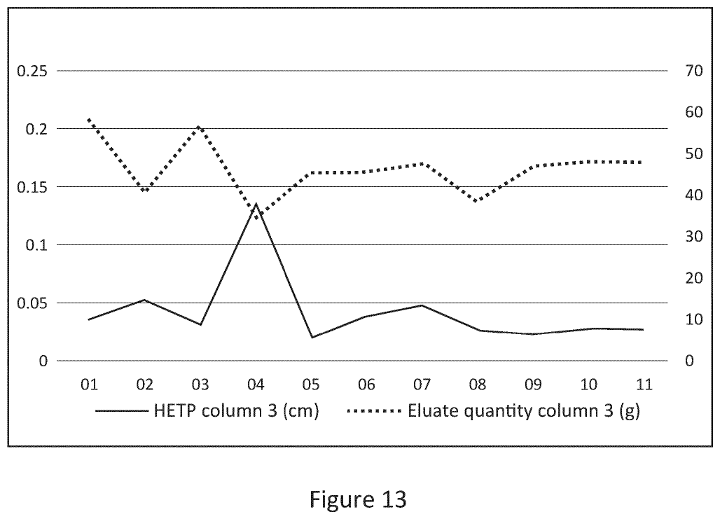

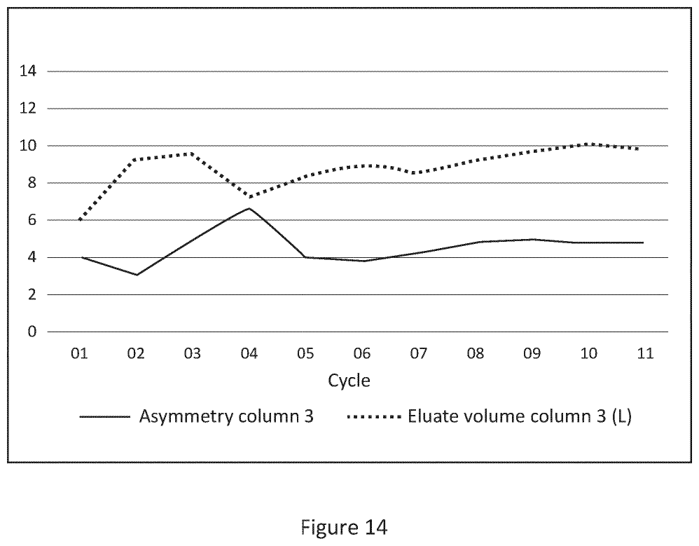

During the continuous run we collected the elution peaks and evaluated their volume and quantity of Immunoglobin G by measure at 280 nm with NANODROP™ system (Thermofisher, Waltham, MA). If we plotted the result of HETP and quantity of eluate collected (see, FIGS. 9, 11 and 12), we observed that the lower the HETP was measured, the more Immunoglobin G was collected. This shows a real benefit to monitor continuously the quality of capture of the column. The plot of the asymmetry (see, FIGS. 10, 12 and 14) and eluate volume give less information but both values tend as well to increase with the HETP increase and eluate quantity decrease meaning a loss of performance.

What is claimed is:

1. A method of monitoring one or more chromatography columns being operated in continuous process mode for efficiency and quality, the method comprising:
a) providing one or more chromatography columns used in continuous mode;
b) detecting changes in one or more process parameters selected from the group consisting of pH, conductivity, salt concentration, light absorption, fluorescence after excitation with light of a suitable wavelength, refractive index, electrochemical response and mass spectrometry immediately before, during and directly after the exchange of one process fluid to another process fluid that differ in the one or more process parameters to generate process data;
c) applying a curve smoothing filter to said process data to generate corrected process data;
d) calculating the first derivative of said corrected process data to produce derivatized process data of said corrected process data;
e) determine the HETP value and asymmetry of said derivatized data;
f) comparing the HETP value and asymmetry to standardized values;
g) wherein, if the HETP values and asymmetry fall within said standardized values the column is used for another process run.

2. The method of claim 1, wherein said curve smoothing calculation is the Savitzky-Golay smoothing filter.

3. The method of claim 1, wherein said column or columns have been used continuously for between 2 and 200 runs.

4. The method of claim 1, wherein said column or columns have been used continuously for between 5 and 50 runs.

5. The method of claim 1, wherein said continuous process mode comprises at least two but not more than five different columns in sequence.

6. The method of claim 1, wherein said columns are selected from the group consisting of affinity, ion exchange, size exclusion, reverse phase, chiral, frontal and hydrophobic.

7. The method of claim 1, wherein each column is monitored for efficiency and quality.

8. The method of claim 1, wherein said continuous process mode comprises multiple process steps, comprises at least two but not more than ten process steps in sequence and at least one process step comprises a chromatography column.

9. The method of claim 1, wherein said standardized values are based on historic data using the same or substantially the same columns and process parameters.

10. The method of claim 1, wherein if the HETP values and asymmetry do not fall within said standardized values the column is regenerated.

11. The method of claim 1, wherein if the HETP values and asymmetry do not fall within said standardized values an operator is notified by an automatic system.
